(19) United States
(12) Patent Application Publication
(10) Pub. No.: US 2010/0061190 A1
(43) Pub. Date: Mar. 11, 2010

(54) Vehicle log calculator

(76) Inventor: Kenneth W. Nelson, Taylorsville, UT (US)

Correspondence Address: Kenneth Nelson, 3454 W., 5470 S., Taylorsville, UT, 84118, US

(21) Appl. No.: 12/283,073

(22) Filed: Sep. 9, 2008

(51) Int. Cl. G04B 47/00

(52) U.S. Cl. 368/10

(57) ABSTRACT

A calculator is provided to assist a vehicle operator with the task of filling out and maintaining their log books. The calculator includes an input device that may receive a signal in accordance with the setting and release of the parking brake. The input device may also be a physical button pressed by the vehicle operator. A clock may be built into the device to provide current time and date. The input device provides a time stamp that may be altered or varied as directed by the user. A filter may be used to select and remove specific display data, such as an activity with a duration of less than a predetermined time which may be 7.5 minutes. A rounding algorithm may be used to generate rounded times in which the time stamp data may be rounded to the closest fifteen minute increment. These rounded times may be stored in a register to be recalled and arithmetically analyzed to assist the user in filling out and keeping the log books up to date.

### FIELD OF THE INVENTION

The present invention generally relates to electronic calculators and, more particularly, to a calculator used to facilitate computation of a vehicle driver's log.

### BACKGROUND OF THE INVENTION

Many vehicle operators are required to maintain a log book accounting for the driver's time. This is done for safety reasons in that a fatigued operator is more likely to be involved in a vehicular accident. In many cases the driver's regulations have become so complicated that it is difficult for the driver to accurately report their time. In addition, many errors in filling out the log can be caused by the driver concentrating on their primary job, getting the vehicle from point A to point B. A driver may stop to fill up with fuel and forget to note the time of day at that moment. Then upon getting into the vehicle again, the driver will need to play the memory game to try to remember what time what happened and then transcribe that into the proper place and category in the log. The task is simple enough, but with the volume of information, it can sometimes get away from even the most experienced of drivers. A single unintentional error can result in a hefty fine to the driver.

Attempts have been made to try to remove this process from the driver by integrating sensors in the vehicle and have this data report back to a centralized location to be analyzed. Several issues with that exist. First the driver is still required by law to maintain the log book, so any transmitted data is redundant. Secondly, much of the raw data from the vehicle, such as knowing that the truck is not moving may be ineffective in accessing the category of the driver. For example a stopped vehicle could be stopped in traffic, and therefore it would be considered driving time. The driver could be asleep and therefore it would be considered sleeper time. The driver could be at a movie and it would be considered off duty, or the driver could be refueling and it would be considered on duty-not driving. Only the driver knows the circumstances and therefore the category for that time period.

It should, therefore, be appreciated that there is a need for a device and method of assisting the driver in keeping track of, categorizing and accumulating the driver's time. The present invention fulfills this need and others.

### SUMMARY OF THE INVENTION

The present invention provides a display, a clock which provides a time output, an input device adapted to provide a time input in accordance with the current time, a processor, including a minimum activity filter and a rounding algorithm, for receiving the data from the clock and the input device and displaying this data on the display and a memory storage adapted to receive and store this data. The device may also include a housing to support these elements in a hand held unit. The minimum activity filter may remove any activity and associated duration of time that is less than a predetermined period of time such as 7.5 minutes, adding that time to the previous activity entry. The rounding algorithm converts the time input to the closest 15 minute increment.

In a presently preferred embodiment of the invention, the display may include areas adapted to display and activity list. The activity list may include “off duty”, “sleeper”, “driving” and “on duty”.

In one embodiment of the invention, the input device includes a mechanically actuated switch in physical communication with a parking brake of the vehicle. In another embodiment, the input device includes a voltage sensor in electrical communication with a circuit that is responsive to the parking brake of the vehicle. This circuit may be the parking brake indicator light circuit. In another embodiment of the invention, the input device may be a switch supported by the housing of the device.

An exemplary method for calculating vehicle log data is also disclosed. The method includes use of the elements as noted above and includes the steps of providing an input from the input device in accordance with the current time and stored as time data. The data may be filtered to ignore certain activities with a duration of less than a predetermined period of time, such as 7.5 minutes. Time data may be rounded to a predetermined increment such as the nearest fifteen minute interval, thereby generating a rounded time, which is stored and displayed. The rounded time is subtracted from the previously stored rounded time to generate the elapsed time, which is displayed on the display.

The method may also include calculating cumulative drive time over a period of time and displaying this as a cumulative drive time. Also, the cumulative on duty time may be calculated over a period of time. The cumulative drive time and on duty (but not driving) time may be calculated to obtain the on duty plus drive time, which can also be displayed on the display.

The method may include an edit command that allows a data element to be modified. A data element may include the activity categories including off duty, sleeper, driving and on duty or the data element may also be an element of time. The edit command may include the steps of displaying a default data element, providing an edit sequence input, displaying the edit option data elements on the display, selecting an edit option data element and displaying and storing the edit option data element in place of the default data element.

The method may also include the steps of providing a circuit including a switch in physical or electrical communication with a parking brake on a vehicle, providing a voltage input to the circuit and actuating the switch by movement of the parking brake. The circuit voltage is then sensed to determine the parking brake status.

For purposes of summarizing the invention and the advantages achieved over the prior art, certain advantages of the invention have been described herein above. Of course, it is to be understood that not necessarily all such advantages can be achieved in accordance with any particular embodiment of the invention. Thus, for example, those skilled in the art will recognize that the invention can be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following description of the preferred embodiments and drawings, the invention not being limited to any particular preferred embodiment(s) disclosed.

### BRIEF DESCRIPTION OF THE DRAWINGS

Embodiments of the present invention will now be described, by way of example only, with reference to the following drawings, in which:

FIG. 1 is an isometric view of one embodiment of a vehicle log calculator produced in accordance with the present invention.

FIG. 2 is an isometric view of a second embodiment of a vehicle log calculator with a limit switch disassembled from the plug.

FIG. 3 is an isometric view of the vehicle log calculator of FIG. 2 shown in a position as it may be positioned relative to a brake knob.

FIG. 4 is a front view of the vehicle log calculator of FIG. 1 illustrated with displayed data on the display.

FIG. 5 is a front view of the vehicle log calculator of FIG. 1 shown with multiple display zones.

FIG. 6 is a front view of the vehicle log calculator of FIG. 1 shown in one step of an edit command.

FIG. 7 is a front view of the vehicle log calculator of FIG. 6 shown in a subsequent step of an edit command.

FIG. 8 is a front view of the vehicle log calculator of FIG. 6 shown with a display edited.

FIG. 9 is a front view of the vehicle log calculator of FIG. 8 in one step of a line edit command.

FIG. 10 is a front view of the vehicle log calculator of FIG. 9 with a display line edited.

FIG. 11 is a front view of the vehicle log calculator of FIG. 10 in one step of an edit command.

FIG. 12 is a front view of the vehicle log calculator of FIG. 11 with a summary option screen displayed.

FIG. 13 is a front view of the vehicle log calculator of FIG. 12 with a sample of a daily summary displayed.

FIG. 14 is a front view of the vehicle log calculator of FIG. 12 with the summary option screen displayed.

FIG. 15 is a front view of the vehicle log calculator of FIG. 14 with a sample of an eight day summary displayed.

FIG. 16 is a front view of the vehicle log calculator of FIG. 15 with alternative data displayed.

FIG. 17 is a front view of an alternative embodiment of the vehicle log calculator of FIG. 1 with a switch as an input device, the switch being actuated by a parking brake knob.

FIG. 18 is a front view of the vehicle log calculator of FIG. 17 with the switch disengaged by the parking brake knob.

FIG. 19 is a flow chart of an example of a logic sequence of the vehicle log calculator.

### DETAILED DESCRIPTION OF THE INVENTION

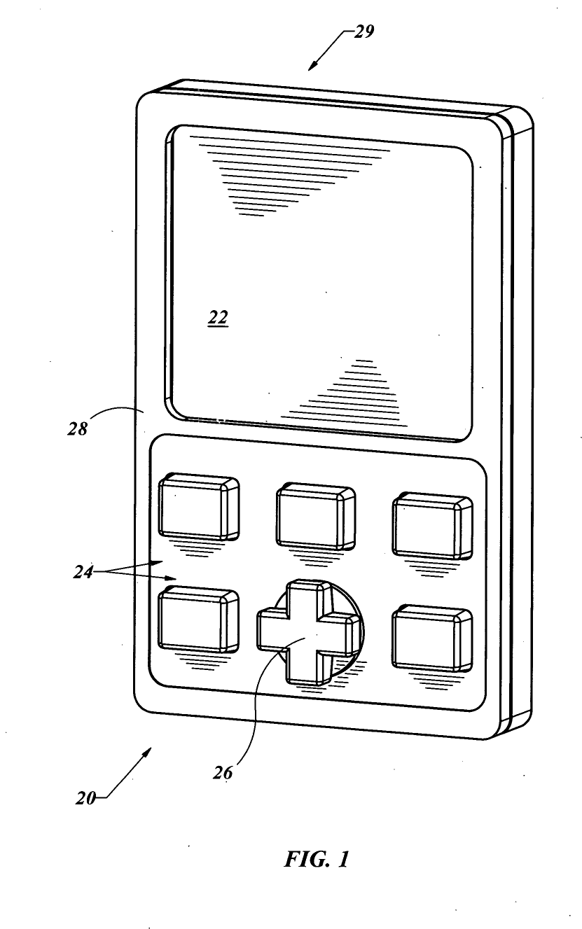

With reference to the illustrative drawings, and particularly to FIG. 1, there is shown a device in the form of a vehicle log calculator 20 with a display 22 and multiple input devices, in this embodiment these are shown as individual buttons 24 and a joystick button 26. A housing 28 may be provided as an encasement to allow the device 20 to be portable and hand held thereby allowing a user to keep the device 20 in the vehicle or remove it and take it to another vehicle or to another location to update data. All items inside and including the housing 28 will be referred to as the device large base 29.

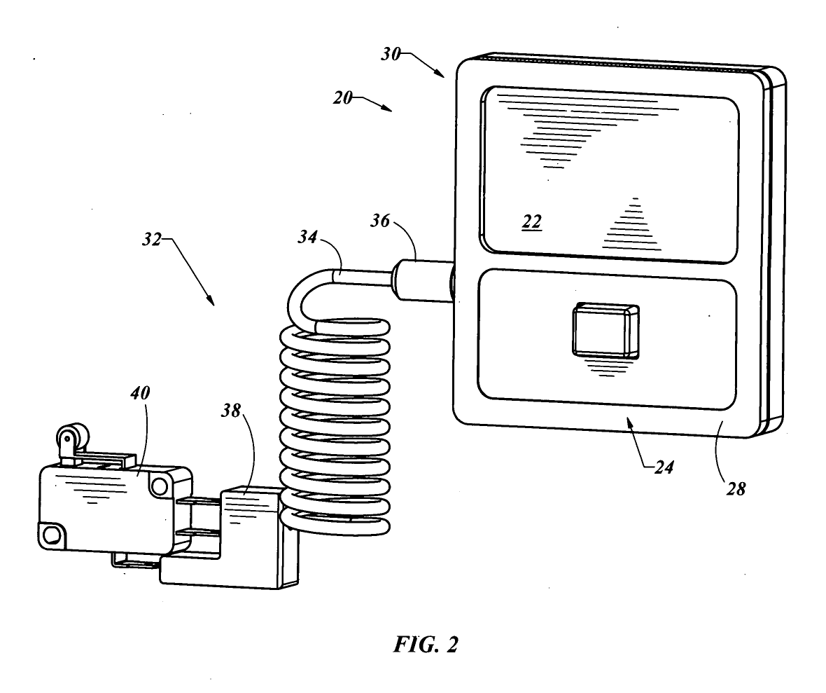

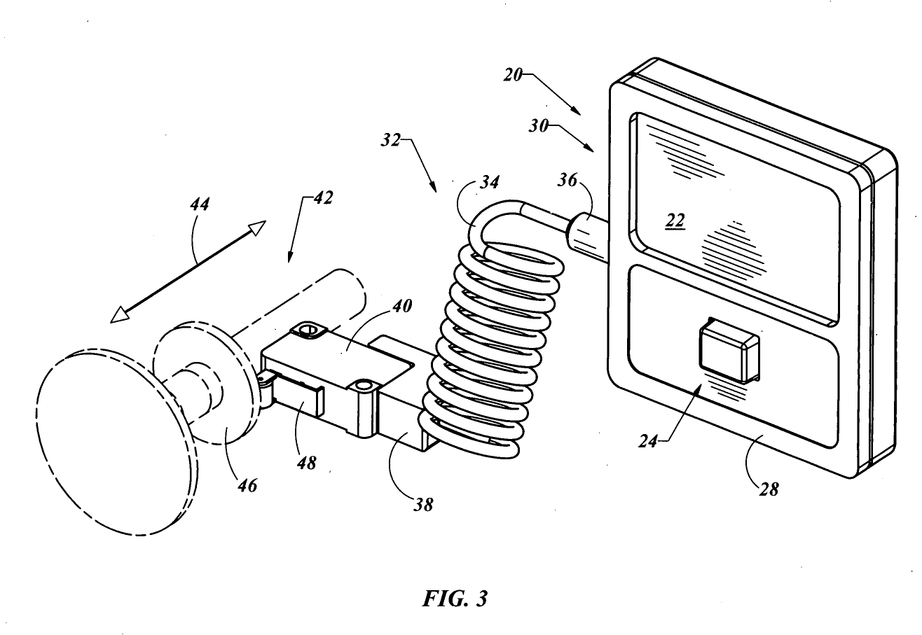

With reference to FIGS. 2-3, an alternative embodiment of the device 20 of FIG. 1 is shown. In FIG. 2 a simplified base 30 is shown with a display 22 supported by a housing 28, but in this embodiment there are two input devices, a button 24 and a switch and cable assembly 32. The button 24 may have several functions including those detailed later in the disclosure. The switch and cable assembly 32 may take many forms, one of which is illustrated here. It is understood that the specific details of the elements of the switch and cable assembly 32 may vary, but the general function of providing an input to a processor located in the housing 28 of the simplified base 30 remains constant. In this form of the switch and cable assembly 32 a cable 34 is received into the simplified base 30 by a cable plug 36. The cable 34 may be hard wired and therefore permanently fixed to the simplified base 30, but it may be desirable to have the simplified base 30 be portable and therefore removable from the cable 34, which may stay with the vehicle. An alternative form of portability of the simplified base 30 is also illustrated here by use of a switch plug 38 on the other end of the cable 34. In this way the cable 34 may be hard wired to the simplified base 30 and removed from a switch 40 that may be securely mounted to the vehicle. The switch plug 38 may be used to free the simplified base 30 from the switch 40, or the cable plug 36 may be likewise used to release the simplified base 30 from the cable 34. Either or both methods, or any other method of data communication, such as the use of wireless transmitters and receivers in the simplified base 30 and associated with a switch 40 may be used in this or any other form of the invention without altering the spirit of the invention.

An application of the switch 40 is illustrated in FIG. 3. A vehicle brake knob 42 is provided as it may be orientated relative to the switch 40 and mounted to the switch plug 38, which is in electrical communication with the simplified base 30 by way of the cable 34. Movement of the brake knob 42, as illustrated by the arrow 44, enables actuation of the switch 40 by contact of the knob flange 46 with the switch arm 48. When the brake knob 42 is pulled forward, away from the switch 40, the knob flange 46 is released from the switch arm 48 and the switch 40 would be closed if the switch 40 is wired to be NC (normally closed). In a similar manner, if the switch 40 was wired to be NO (normally open), this action would open the circuit. Pushing the brake knob 42 in toward the switch 40 may cause the flange 46 to contact the switch arm 48, closing the circuit if the switch 40 is wired to be NO and opening the circuit if the switch 40 is wired to be NC. In this way the status of the parking brake of the vehicle can be signaled by the position of the brake knob 42. In many vehicles the brake is set if the brake knob 42 is pulled out and the brake is released when the brake knob 42 is pushed in though any configuration may be used.

Other forms of sensing the engagement of the parking brake can be done including providing an electronic switch, which may be housed in the base 29 or simplified base 30. This may be on a circuit board that may also include one or more items including a clock for providing a time input, a processor for receiving data from the clock and the input device and providing display data to the display, and memory storage to receive and store display data. The switch may sense a voltage or current flow in a circuit that may be operatively controlled by the parking brake of the vehicle. In some cases a light is present in the vehicle that is representative of the engagement status of the parking brake. The electronic switch of the device 20 may be adapted to detect the current flow or voltage present when the light is illuminated versus not illuminated. Changes from one status to another are detected and recorded by the processor with the current time, thus denoting a potential change in driving status, hereby referred to as a time stamp.

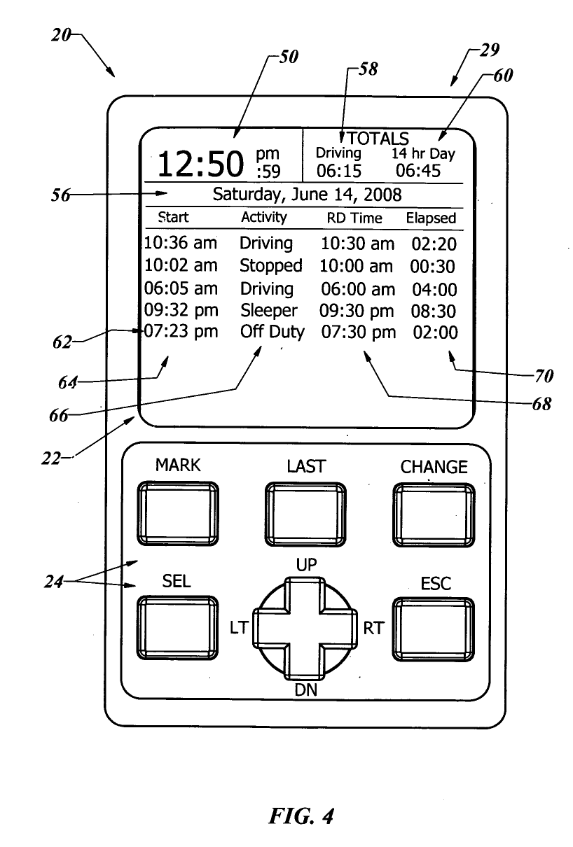

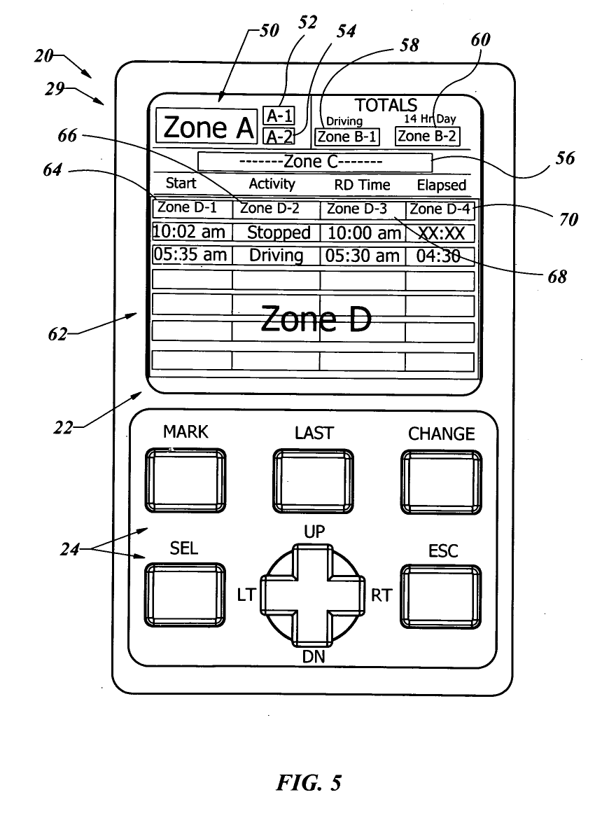

With reference to FIGS. 4 and 5, one example of the large base 29 version of the invention, as in FIG. 1, is shown with one embodiment of the graphics illustrated in FIG. 4 and some displayed data has been classified in zones on the display 22 in FIG. 5. Referring to FIG. 4 for a sample of data and referring to FIG. 5 for the zone, “Zone A” 50 may show the actual time, with “Zone A-1” 52 designating morning or afternoon and “Zone A-2” 54 giving current seconds. In that this is a vehicle that may move from one time zone to another, the base 29 may include GPS (global positioning system) capability to track the location automatically and update the time accordingly and also potentially to provide vehicle position data. The date may be shown in “Zone C” 56.

This is all valuable information to a vehicle operator in that The Department of Transportation (DOT) provides limits to the number of hours that a commercial driver may operate a vehicle over a given period of time. A driver is required to keep detailed written records of the number of hours spent in each of the four basic categories: Off Duty, Sleeper, Driving and On Duty. This time must be accurately recorded to the closest fifteen minute increment. The DOT may impose substantial fines for errors in recording this information or for exceeding the limits provided. These limits may include a total “Driving” time limit, a “14-hour” maximum limit and a “70-hour” limit that includes the Driving and On Duty-Not Driving cumulative time over an eight day period. In some instances a “60-hour” limit over a seven day period is used. Examples of totals the operator may want to keep track of are given in “Zone B-1” 58 and what is referred to as the “14-hour Limit”, displayed in “Zone B-2” 60. These limits are reset after a minimum time period of “Off-Duty” or “Sleeper” time has been accumulated. The regulations may vary depending on several factors and driving responsibilities or duties and different limitations may apply. A set-up feature may be provided to allow the appropriate settings to be made for each user. It is understood that these variations are not substantive and inherently fall under the scope of this disclosure though only one set of variables may be used.

A “Zone D” 62 may display a sequential time stamp of activities as generated by the input device such as a button 24 or the cable and switch 32 as shown in FIGS. 2 and 3 or any similar system. The display data may be listed in four columns, noted as Zones “D-1” 64, “D-2” 66, “D-3” 68 and “D-4” 70. The activity is noted in Zone “D-2” 66 with the actual time this activity started as being recorded in Zone “D-1” 64. It may be desirable that activities and times be filtered to eliminate relatively short stops and starts that would do little more than quickly fill up the display with unimportant data. Individual short duration starts and stops, such as while slowly moving ahead to a weight station, do not constitute a change in status and therefore may be removed from the display data. A minimum activity filter may be provided in the processor of the device 20 to ignore activities with time increments of less than a predetermined period of time. This period may be seven minutes and thirty seconds in length. This filtering process may include additional logic that may analyze the sequence of events or other criteria to automatically remove or filter out data that may not represent a change in status, such as in this case identified by a short duration.

All activities may be rounded to the closest fifteen minute increment by a rounding algorithm. These times are listed in Zone “D-3” 68 as rounded time or “RD Time”. The top line in “Zone D” in FIG. 5 shows an example of rounding down, where the start time is 10:02 a.m. which has been rounded to 10:00 a.m. in Zone “D-3” 68. The bottom line in “Zone D” of FIG. 4 shows a start time of 07:23 p.m. in Zone “D-1” 64, which has been rounded to 07:30 p.m. in Zone “D-3’ 68. The final column, denoted as Zone “D-4” 70, may be the difference between the each RD Time and the previous RD Time (Zone “D-3”) 68 listed directly above it. The uppermost Elapsed Time (Zone “D-4”) 70 does not have an RD time above it to subtract from, therefore may display the difference between the current time (“Zone A”) 50 and the RD Time 68 of that top line. When a new entry is made, a new top line will be added, the elapsed time (Zone “D-4”) 70 will be updated and all entries will move down one slot and the new entry added as a new top line.

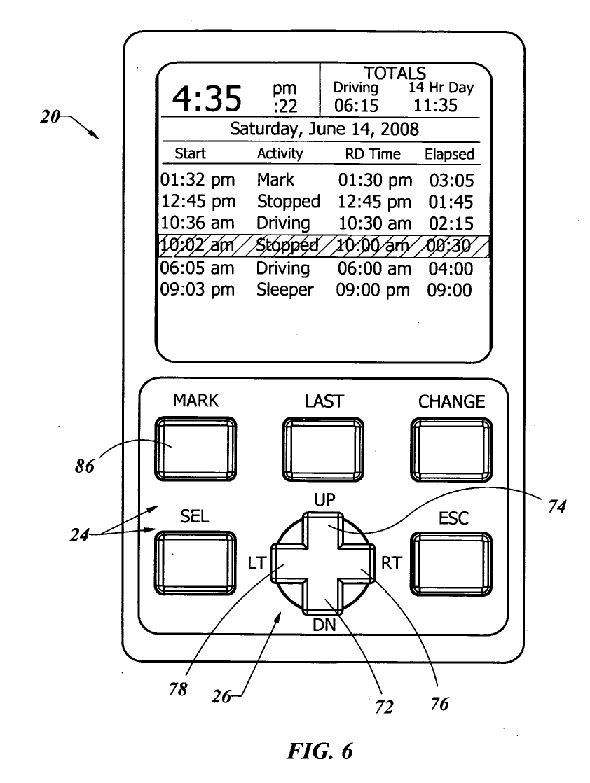

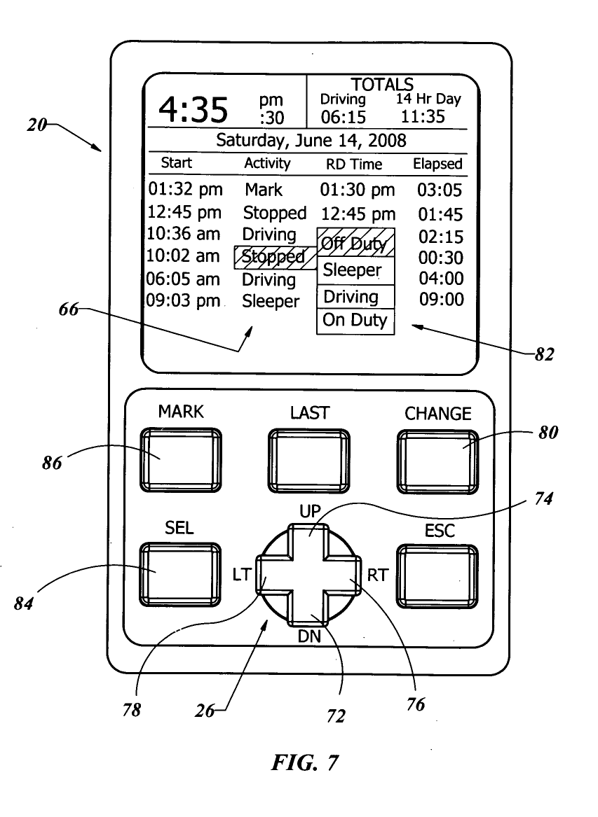

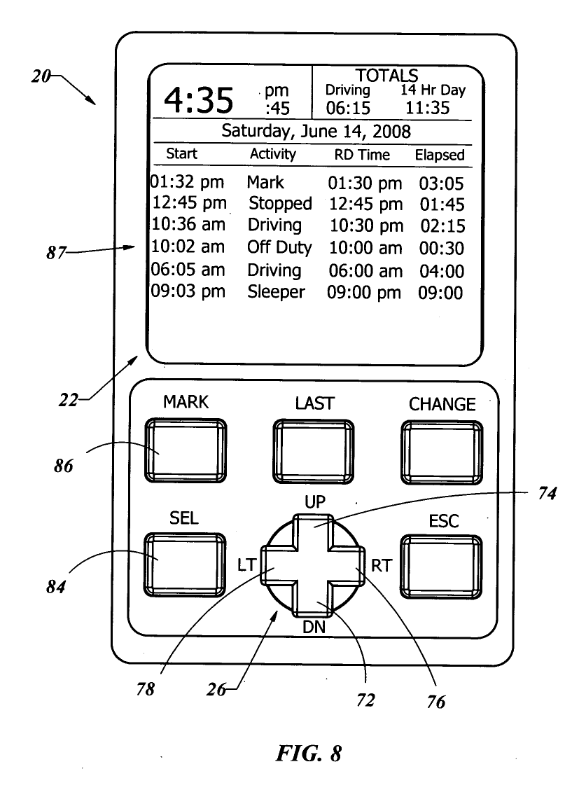

In many cases the data will need to be modified. One example of this is shown in FIGS. 6-8. Referring to FIG. 6 a user may press the down toggle 72 and the up toggle 74 of the joystick button 26 to scroll down line by line. Each line may be highlighted to alert the user that this data set is identified. When the line desired to be modified is highlighted, the user may use the right toggle 76 and the left toggle 78 to identify the specific column within that line that is desired to be altered. In FIG. 7 the activity column 66 has been selected. One method of changing that segment of data would be to then select a “change” button 80. This may initiate a pull-down menu 82 which may be specific to that particular data set. Regarding the “Activity” this may include the four options of: Off Duty, Sleeper, Driving and On Duty. The step of selecting an option may again be accomplished by using the down toggle 72 and the up toggle 74 until the desired activity is highlighted. To accept that change the select button 84 may be used. This series of steps is one method of changing a data entry (“Stopped” in FIG. 6) to a new data entry (“Off Duty” in FIG. 8). The fourth line 87 in FIG. 8 shows the updated entry on the display 22.

The value of editing the data is that when an input is made to the device 20 either by pressing one of the buttons (identified in general as 24) or in one example specifically the mark button 86 or by a switch and cable assembly 32 as shown in FIGS. 2 and 3, a default activity will be entered with the start time and rounded time as previously discussed. The default may be set by the user to be any entry that user feels is most relevant. One example would be when the parking brake is set, the default activity is “Stopped” in that this would be the most likely situation and due to the variety of stopped activities (off duty, sleeper and on duty) this alerts the operator that it must be changed to one of the suggested categories. This case or when the default is not correct, the ability to edit is important. For example, an operator may be stopped at a train crossing for several minutes and sets the parking brake. The vehicle is sitting on the road trying to move, so this may be considered “driving”. In this situation, if the time with the parking brake set is less than seven minutes and thirty seconds, the minimum activity filter may eliminate the entry and add the time to the previous entry, making that previous entry the current entry. If an entry is edited to be the same activity as the entry above or below the edited entry, the adjacent entry times may be added to make one entry. In the case of the operator waiting for the train, once the train passes and the operator is free to proceed, the parking brake will be released at which time a new entry will be made and the default may be to “driving”. If this is correct, the operator may later edit a “stopped” entry that may have been entered as a default when the parking brake was set, changing the activity to “driving”. If the operator drove to the railroad crossing, the device 20 may have been accumulating that time as “driving”. After the operator releases the parking brake, he will be driving again and the default setting to the device 20 may reflect that. Therefore, if the “stopped” time at the crossing is changed, there would be three “driving” entries in a row. Since these may all be considered “driving” the times may be summed into a single “driving” entry. The result is a more concise summary for the operator to use in his log.

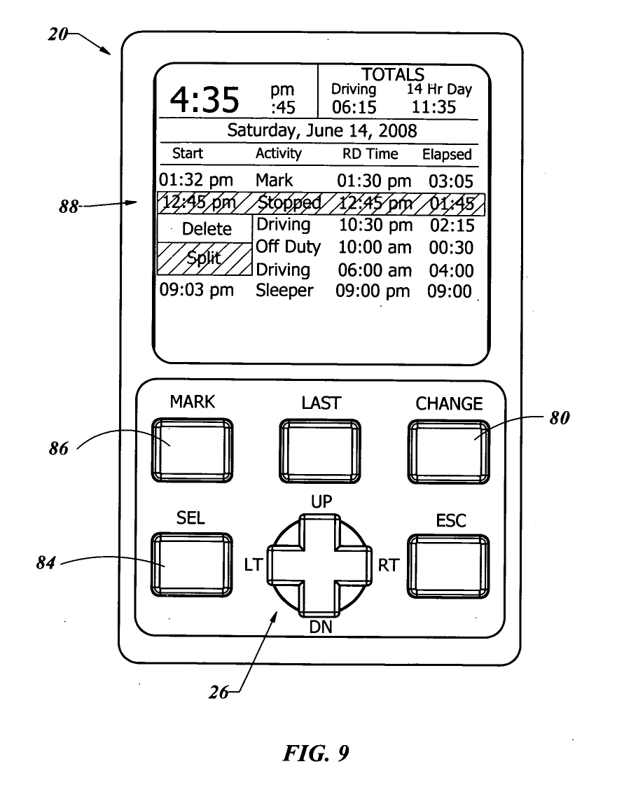

Other forms of editing may include editing an entire line. One example of this is illustrated in FIGS. 9-11. Examples of when line editing is desirable include deleting a line entry or splitting a line entry. In the previous example, if the operator stopped and set the parking brake and a “stopped” entry was made, and the operator desired to remove it and add it to the previous “driving” entry, the operator may also delete the line entry. This may add the time accumulated in that deleted entry to the previous line entry and categorize that accumulated time under that as noted in the previous entry. As an example, in FIG. 9 the second line 88 is selected. This may be by using the joystick button 26 in a manner as previously disclosed. With the entire line 88 highlighted, the user may push the change button 80. This may prompt a pull-down associated with editing the line and not just an element of the line, as was shown previously. The editing of the line 88 may include two options, delete and split. The user may manipulate the joystick button 26 as previously described to highlight the desired option. The select button 84 may be used to accept this option. In this example the “split” option is selected.

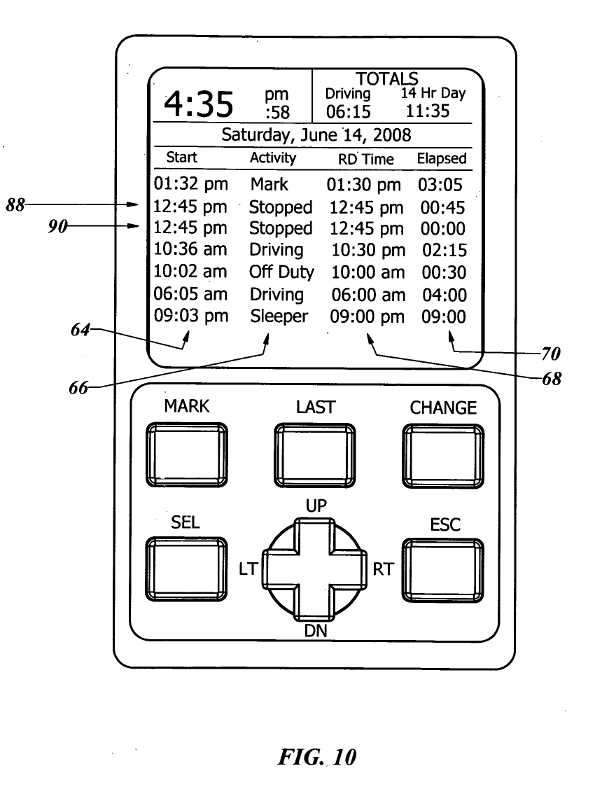

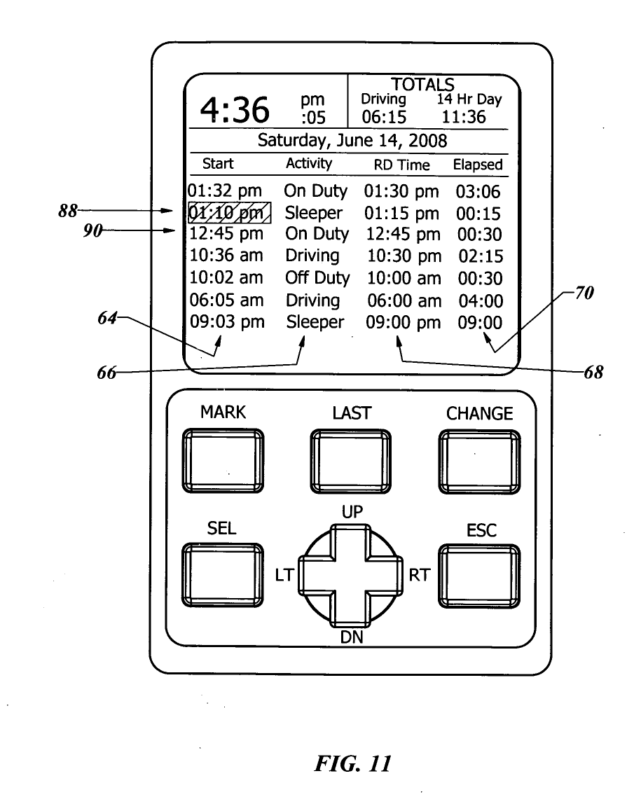

Referring to FIG. 10, the second line 88 remains as it was. A new third line 90 has been added. The start time 64, activity 66 and rounded time (RD Time) 68 are duplicated from the parent line, in this case the second line 88. Another option would be to make the activity section of the new line a default that alerts the user that this should be edited. An example would be the word “Inserted” or “Split” could be used instead of a duplicate of the activity section of the parent line. The elapsed time 70 is the difference between that RD times 68 of that entry and the entry directly above it. These RD Times 68 are identical, therefore the difference is zero and is noted as such in the third line 90 of the elapsed time 70. For this data to be valuable, one of the lines would be edited to reflect any time and activity changes. The edit process as previously described may be used to change any of the data. With reference to FIG. 11, the start time 64 of the second line 88 is modified as well as the activity 66 of both lines 88 and 90. In changing the start time 64, the RD time 68 may adjust accordingly to the nearest fifteen minute increment by way of the rounding algorithm associated with the processor. The change in the RD time 68 of the second line 88 then changes the elapsed time 70 of the second line 88 and third line 90 are adjusted accordingly.

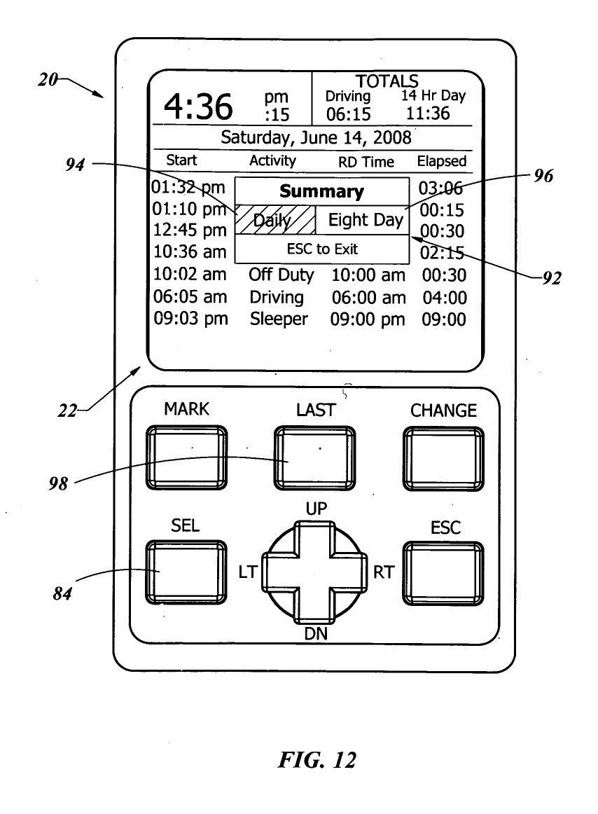

Another advantage to the user is illustrated in FIGS. 12-15 in that the device 20 may provide summary reports to further assist the operator in compiling their driver's log. Giving particular attention to FIG. 12 a summary window 92 is positioned on the display 22 with two summary options, daily summary 94 and an eight day summary 96. The data displayed in this window may change as other data becomes more relevant, such as when a regulation limit is near to an accumulated total generated by the device 20. This window 92 may be obtained by pressing a single button or some combination simultaneously, such as the select button 84 and the last button 98. Pressing the last button 98 alone, the last button 98 may move the selection or editing process to the last window or entry, whatever is relevant. The last button 98 may also be used to recover a record that the filter has removed, thus recovering that data to be used by the operator.

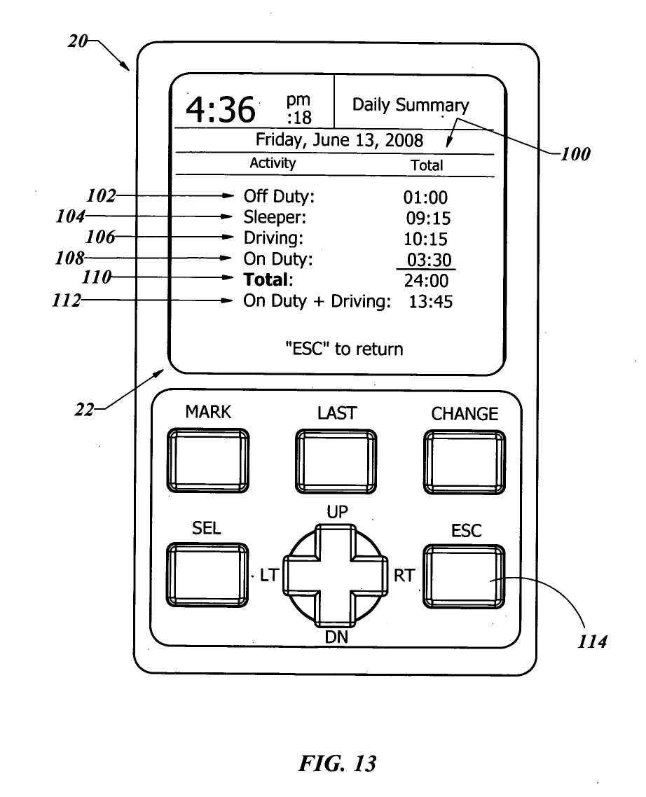

Selection of the daily summary 94 as noted in FIG. 12 is shown in one embodiment on the display 22 of the device 20 in FIG. 13. In this embodiment the sums of the totals 100 of the categories of: Off Duty 102, Sleeper 104, Driving 106 and On Duty 108 may be displayed for that period as a day as defined by some criteria, which may be in accordance with any regulations, from midnight to midnight, or any other criteria desired. A total 110 may provide a sum of all the aggregate times of all the categories. A final summary may be used as the combined totals of the on duty category 108 and the driving category 106. This on duty+driving combination 112 may be useful in providing feedback to the operator so as to assist the operator in not violating the regulations by going over the current 14 hour daily or 70 hour limits. In all the summary screens the escape button 114 may be pushed to exit the summary screen and roll back to the current line time stamp screen as in FIG. 10.

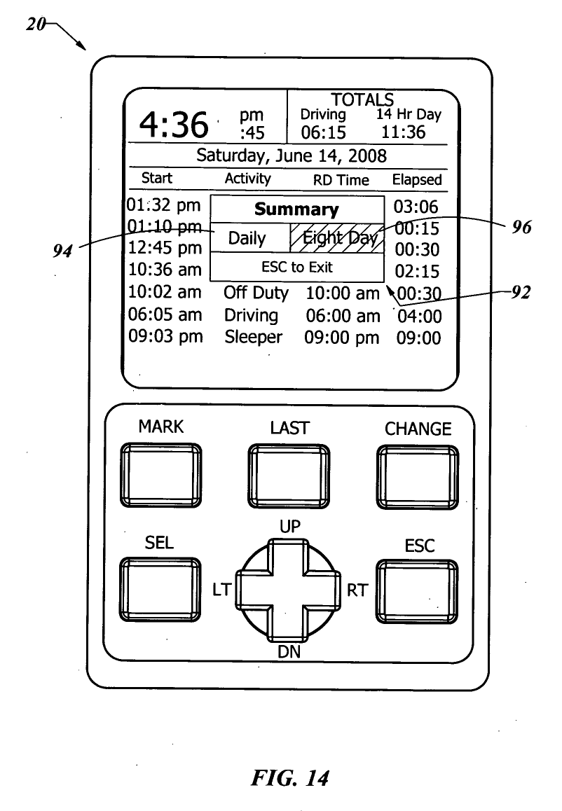

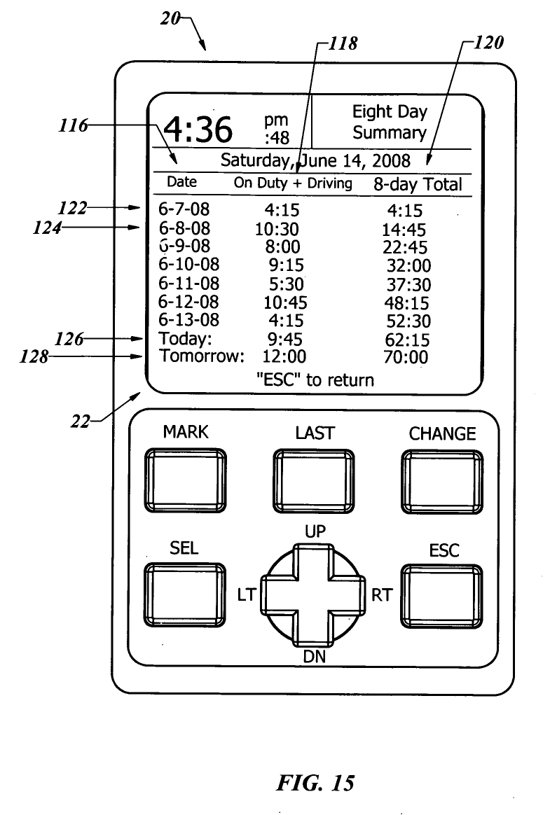

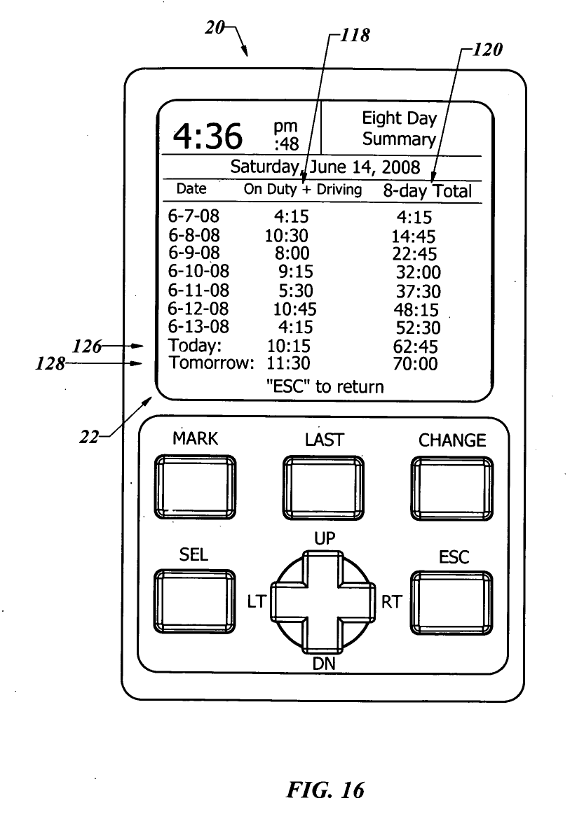

An Eight day summary 96 of the summary window 92 is selected in FIG. 14. Examples of variations of one embodiment are shown in FIGS. 15 and 16. Referring to FIG. 15 a date column 116 may be positioned on one side of the display 22 showing the past seven days by date. Each date row may include data in an on duty+driving column 118 and an eight day total column 120. The data in the on duty+driving column 118 is calculated as per the daily summary example in FIG. 13. Each of the former seven days may be displayed with that total in the on duty+driving column 118 and a cumulative total of the data in the on duty+driving column 118 in the eight day total column 120. For example, the top row 122 has four hours and fifteen minutes (04:15) listed in the on duty+driving column 118. This number is carried over to the eight day total column 120 in the top row 122. The second row 124 has ten hours and thirty minutes (10:30) listed in the on duty+driving column 118. This is added to the previous total of four hours and fifteen minutes (04:15) in the first line 122 to obtain fourteen hours and forty-five minutes (14:45) in the eight day total column 120 of the second line 124. This additive process may continue to the lower portion of the display 22 until “Today” is listed on the eighth line 126. The ninth line 128 lists “Tomorrow” as an additional guide to the operator. Some regulations may limit the eight day total to be seventy hours (70:00). If the operator would look at the device 20 the following day (Sunday, June 15^{th} by the example shown), the “Tomorrow” data in the ninth line 128 would shift up to be “Today” and positioned in the eighth line position. As such, the data in the first line 122 will drop off and be replaced by the current data of the second line 124. Therefore on Saturday, June 14^{th} in this example, to reach seventy hours (70:00) “tomorrow” the seven hours and forty-five minutes (07:45) difference between sixty-two hours and fifteen minutes (62:15) and seventy hours (70:00) plus the four hours and fifteen minutes (04:15) that will drop off the top line 122, adds to twelve hours (12:00) in the “Tomorrow”, ninth line 128 to get to seventy hours (70:00) total. This gives the operator an idea so as to plan the next day. As an additional example FIG. 16 illustrates how if the data in the eighth line 126 were changed by adding an additional thirty minutes to the on duty+driving column 118 the total for the next day listed in the ninth line 128 would be reduced by thirty minutes from twelve hours (12:00) in FIG. 15 to eleven hours and thirty minutes (11:30) in FIG. 16 to add up to seventy hours (70:00).

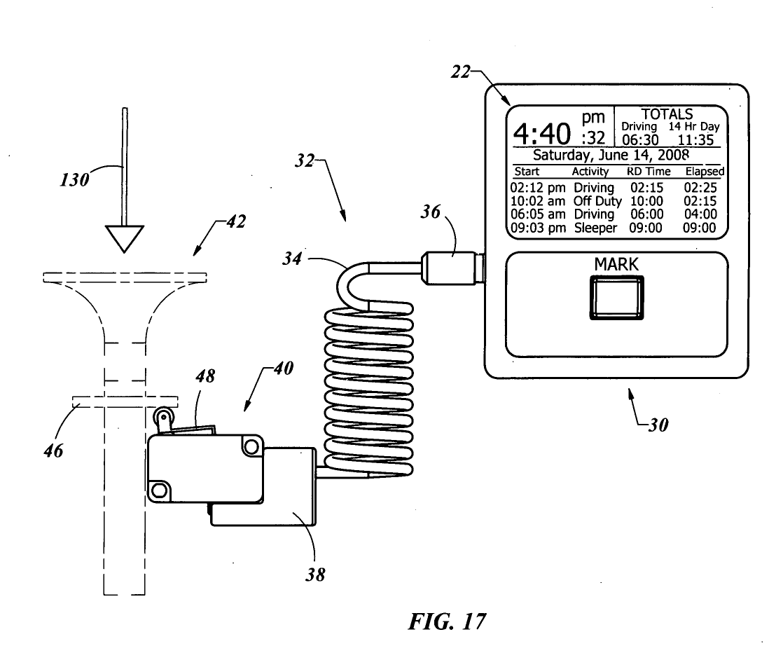

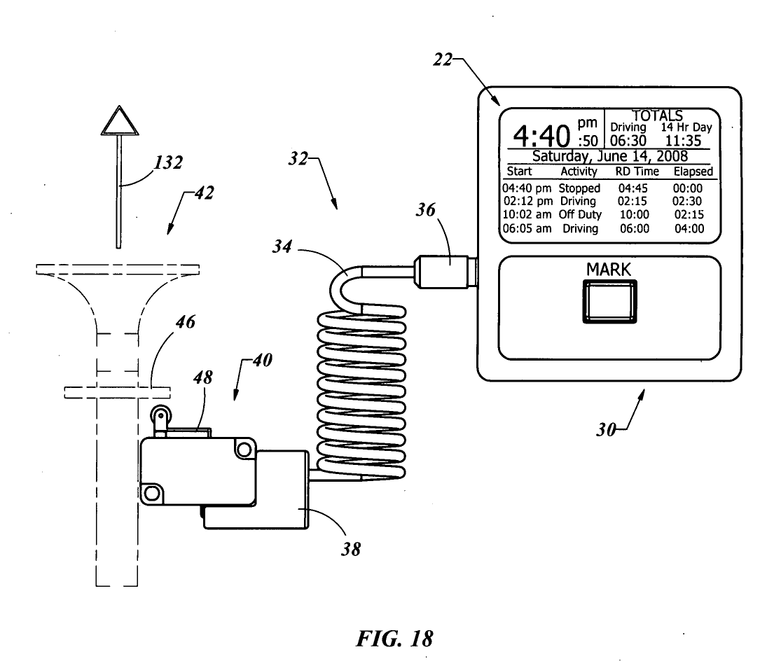

One example of how an input device in the form of a switch and cable assembly 32 connected to a simplified base 30 is shown in FIGS. 17 and 18. In FIG. 17 the brake knob 42 is pressed in to illustrate a parking brake being released as is denoted by the down arrow 130. The brake knob 42 may include a knob flange 46 that is adapted to actuate the switch arm 48. In this embodiment the knob flange 46 actuates the switch arm 48 in this position. In FIG. 18, the brake knob 42 is shown to be pulled out in the direction of the up arrow 132, thereby removing the knob flange 46 from the switch arm 48 and allowing the switch 40 to be in its normal state. If a voltage is sent from the simplified base 30 through the cable 34, the difference between an open and a closed switch 40 may be detected by a processor housed in the simplified base 30. This change in status by movement of the brake knob 42 will provide a signal to the simplified base 30 that a time stamp is recorded, which is then displayed on the display 22. This switch and cable 32 arrangement or any similar system can be used in conjunction with any form of the device 20 including the large base unit 29 as shown in FIG. 4.

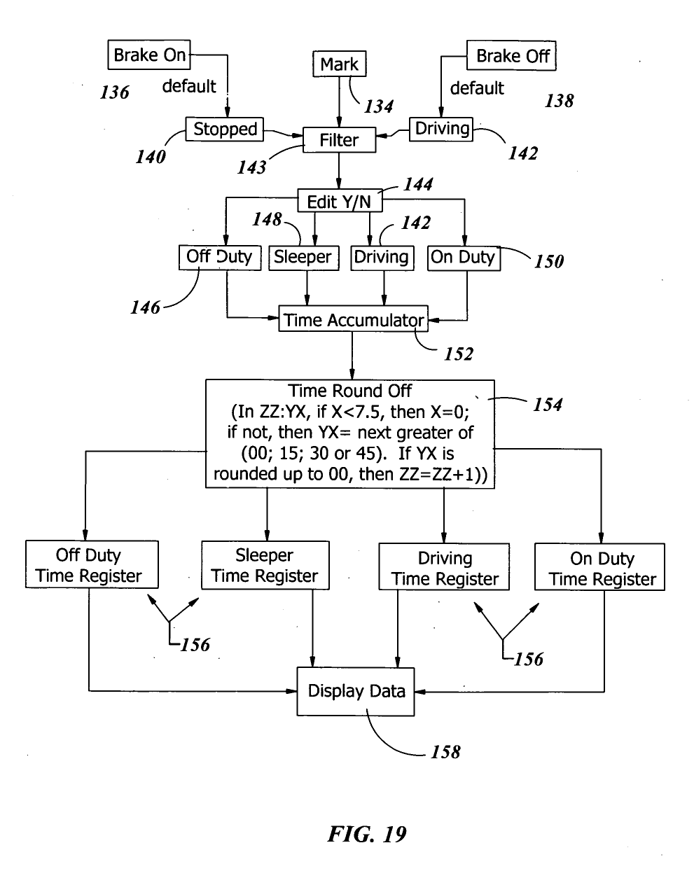

A flow chart of one embodiment of the invention 20 is shown in FIG. 19. An input is received by the mark 134 or by a detection of the brake on 136 or brake off 138. A default input for the brake on 136 may be stopped 140 and for the brake off that the vehicle is driving 142. A filter 143 may be provided to eliminate any timed activity that is less than a predetermined time, such as 7.5 minutes. The capacity to edit 144 may be added to enable the filtered activity of stopped 140 or driving 142 to be more specifically defined such as off duty 146, sleeper 148, on duty 150, or driving 142. A time accumulator 152 tracks the time in each activity over various time frames. Each time frame is rounded to the nearest fifteen minute increment 154. The rounded time increments are accumulated and stored in registers 156, which can be displayed 158 for the user. This method of tracking and displaying data offers vehicle operators guidance as to preparing and maintaining their driver's log.

The foregoing detailed description of the present invention is provided for purposes of illustration, and it is not intended to be exhaustive or to limit the invention to any particular embodiment shown. The embodiments may provide different capabilities and benefits, depending on the configuration used to implement key features of the invention.

What is claimed is:

1. A vehicle log calculator, comprising:
a display;
a clock providing a time input;
an input device adapted to provide a time input in accordance with a current time;
a processor receiving data from the clock and the input device and providing display data to the display, the processor including a filter adapted to distinguish specific display data;
a memory storage adapted to receive and store display data; and
a housing supporting the display, clock, input device, processor and memory storage.

2. The vehicle log calculator according to claim 1, further comprising a rounding algorithm adapted to convert the time input to a rounded time that is rounded to the closest unit of a predetermined time.

3. The vehicle log calculator according to claim 2, wherein the predetermined time is a fifteen minute increment.

4. The vehicle log calculator according to claim 1, wherein the display includes areas adapted to display an activity list, start time, rounded start time and elapsed time listings.

5. The vehicle log calculator according to claim 4, wherein the activity list includes activities from the group consisting of off duty, sleeper, driving and on duty.

6. The vehicle log calculator according to claim 1, wherein the input device includes a mechanically actuated switch in physical communication with a parking brake of the vehicle.

7. The vehicle log calculator according to claim 1, wherein the input device includes a voltage sensor in electrical communication with a circuit responsive to a parking brake of the vehicle.

8. The vehicle log calculator according to claim 7, wherein the circuit responsive to a parking brake is a brake indicator light circuit.

9. The vehicle log calculator according to claim 1, wherein the input device is a switch supported by the housing.

10. The vehicle log calculator according to claim 1, wherein the filter is a minimum activity filter adapted to ignore display data below a predetermined threshold.

11. A method of calculating a vehicle log for use with a device including a display, a clock providing a time input, an input device adapted to provide a time input in accordance with a current time, a processor receiving data from the clock and the input device and providing display data to the display, the processor including a filter adapted to distinguish specific display data, a memory storage adapted to receive and store display data and a housing; the method including the steps of:
providing an input from the input device in accordance with the current time and storing as time data;
filtering time data to remove specific time data;
rounding the filtered time data to a predetermined time interval, thereby generating a rounded time;
displaying the rounded time;
subtracting the rounded time from a previously stored rounded time to obtain an elapsed time; and
displaying the elapsed time.

12. The method according to claim 10, further including the steps of:
calculating cumulative drive time over a period of time; and
displaying a cumulative driving time.

13. The method according to claim 11, further including the steps of:
calculating cumulative on duty time over a period of time;
adding the cumulative drive time and the cumulative on duty time to yield on duty plus drive time; and
displaying the on duty plus drive time on the display.

14. The method according to claim 10, further including the steps of:
providing a edit command, thereby allowing a data element to be modified.

15. The method according to claim 12, wherein the data element is an activity selected from the group consisting of off duty, sleeper, driving and on duty.

16. The method according to claim 12, wherein the data element is a time element.

17. The method according to claim 12, wherein the edit command includes the steps of:
displaying a default data element;
providing an edit sequence input;
displaying edit option data elements on the display;
selecting an edit option data element; and
displaying the edit option data element in place of the default data element.

18. The method according to claim 10, wherein providing an input from an input device includes the steps of:
providing a circuit including a switch in communication with a parking brake on a vehicle;
providing a voltage input to the circuit;
actuating the switch by movement of the parking brake; and
sensing the circuit voltage, thereby determining the state of switch activation and parking brake status.

19. The method according to claim 17, wherein the switch is in physical communication with the parking brake.

20. The method according to claim 17, wherein the switch is in electrical communication with an electrical circuit on the vehicle that is operationally controlled by the parking brake.

21. The method according to claim 11, further comprising a logic sequence to filter display data.

22. A vehicle log calculator, comprising:
a display means;
a clock providing a time input;
an input means adapted to signal a time input in accordance with a current time;
a processor receiving data from the clock and the input means and providing display data to the display, the processor including a display data filter; and
and a memory storage adapted to receive and store display data.
